(19) United States
(12) Patent Application Publication
(10) Pub. No.: US 2022/0248706 A1
(43) Pub. Date: Aug. 11, 2022

(54) COMPOSITION FOR PREPARING COTTON CANDY, A METHOD FOR PREPARING THE COMPOSITION, USE OF THE COMPOSITION FOR THE PREPARATION OF COTTON CANDY, COTTON CANDY SO OBTAINED, AND METHOD FOR MANUFACTURING COTTON CANDY

(71) Applicant: Vincent Tremblay, Quebec (CA)

(72) Inventors: Vincent Tremblay, Quebec (CA); Nicholas Desjardins, Longueuil (CA); Loic Chazay, Montreal (CA)

(73) Assignee: Vincent Tremblay, Quebec (CA)

(21) Appl. No.: 17/670,247

(22) Filed: Feb. 11, 2022

Related U.S. Application Data
(60) Provisional application No. 63/148,321, filed on Feb. 11, 2021.

(51) Int. Cl. A23G 3/10; A23L 27/30; A23G 1/52; A23G 3/52; A23L 21/25

(52) U.S. Cl. CPC A23G 3/10; A23L 27/33; A23V 2002/00; A23G 3/52; A23L 21/25; A23G 1/52

(57) ABSTRACT

A composition for the preparation of cotton candy, said composition being a homogeneous mixture comprising with respect to the total weight of the composition, the following ingredients: from 71.6 wt. % to 99.8 wt. % of particles of at least one food grade sugar; from 0.1 wt. % to 10 wt. % of at least one food grade fat substance, from 0 wt. % to 15 wt. % of particles of cocoa; and from 0 wt. % to 3.4 wt. % of at least one food grade additive. A method for preparing the composition. Use and method for preparing cotton candy. Cotton candy so obtained.

### CROSS-REFERENCE TO RELATED APPLICATION

The present application claims the priority to U.S. Provisional application No. 63/148,321, filed on Feb. 11, 2021, which is incorporated herein by reference in its entirety.

### FIELD OF THE INVENTION

The invention relates to a new composition allowing the preparation of cotton candy, a method for preparing said composition, cotton candy so obtained, and use of said composition for the preparation of cotton candy. Also, the invention relates to a method for manufacturing cotton candy.

### PRIOR ART

Cotton candy is a widespread product. It is in the form of fine fluffy filaments of sugar. To obtain cotton candy, sugar particles are heated to a molten state in a rotary recipient spun in rotation around a vertical axis. Then a centrifugal force exerted on the molten sugar ejects liquid filaments from the rotary recipient, and said liquid filaments are cooled down (by the air contained in a pan surrounding the rotary recipient) to form solid filaments of sugar (i.e. cotton candy).

Several attempts have been made to add some additives (e.g. flavoring agents and/or coloring agents) to make the cotton candy more attractive, tasteful, etc. However, because it is known to persons skilled in the art that the presence of water and/or a fat substance negatively affect the manufacture of the fine fluffy filaments of sugar, additives available to embody cotton candy are quite limited. More particularly, a presence of a water containing additive, cocoa and/or a fat substance must be avoided.

Contrary to expectations of persons skilled in the art, the co-inventors have surprisingly discovered that it is possible to obtain fine fluffy filaments of a composition comprising, preferably consisting of, sugar and at least one fat substance. More particularly, the composition is a homogeneous mixture of particles of at least one food grade sugar, and at least one food grade fat substance.

Also, contrary to expectations of persons skilled in the art, the co-inventors have surprisingly discovered that it is possible to obtain fine fluffy filaments of a composition comprising, preferably consisting of, sugar, cacao and at least one fat substance. More particularly, the composition is a homogeneous mixture of particles of at least one food grade sugar, particles of cocoa, and at least one food grade fat substance.

Also, contrary to expectations of persons skilled in the art, the co-inventors have surprisingly discovered that that the fine fluffy filaments so obtained show unexpected texture and taste that were not possible to obtain before. More particularly, the fluffy filaments so obtained show a surprisingly silky and creamy texture. Also, the fluffy filaments are tasty and delectable.

Also, contrary to expectations of persons skilled in the art, the co-inventors have surprisingly discovered the composition according to the invention can be used in usual cotton candy devices for the manufacture of cotton candy.

Also, contrary to expectations of persons skilled in the art, the co-inventors have surprisingly discovered the composition according to the invention can be used for the manufacture of cotton candy according to the usual process steps, preferably steps required by usual cotton candy devices.

### SUMMARY OF THE INVENTION

Preferred aspects of the invention will be described with reference to the following preferred embodiments [1] to [31]:

[1] A composition for the preparation of cotton candy, said composition being a homogeneous mixture comprising with respect to the total weight of the composition, the following ingredients:
from 71.6 wt. % to 99.9 wt. % of particles of at least one food grade sugar;
from 0.1 wt. % to 10 wt. % of at least one food grade fat substance;
from 0 to 15 wt % of particles of cocoa; and
from 0 to 3.4 wt % of at least one food grade additive.
[2] The composition according to claim 1, wherein said composition comprises with respect to the total weight of the composition, the following ingredients:
from 90 wt % to 99.9 wt. % of the particles of the at least one food grade sugar; and
from 0.1 wt. % to 10 wt. % of the at least one food grade fat substance.
[3] The composition according to embodiment [1], wherein with respect to the total weight of the composition and per 25 gr of the composition, said composition comprises:
from 22.5 gr to 24.975 gr of the particles of the at least one food grade sugar; and
from 0.025 gr wt. % to 2.5 gr of the at least one food grade fat substance.
[4] The composition according to embodiment [1] or [2], wherein said composition comprises up to 3.4 wt. %, preferably up to 0.44 wt. %, of the at least one food grade additive, and wherein said at least one food grade additive is selected from the group consisting of food grade preservatives, food grade flavoring agents and food grade coloring agents.
[5] The composition according to embodiment [1] or [2], wherein said composition comprises up to 3.4 wt. %, preferably up to 0.44 wt. %, of the at least one food grade additive, wherein said at least one food grade additive is selected from the group consisting of food grade flavoring agents and food grade coloring agents.
[6] The composition according to embodiment [1], wherein said composition comprises with respect to the total weight of the composition, the following ingredients:
from 0.1 wt. % to 15 wt. % of the particles of cocoa;
from 74.9 wt. % to 99.8 wt. % of the particles of the at least one food grade sugar; and
from 0.1 wt. % to 10 wt. % of the at least one food grade fat substance.
[7] The composition according to embodiment [6], wherein with respect to the total weight of the composition and per 25 gr of the composition, said composition comprises:
from 0.025 gr to 3.75 gr of the particles of the cocoa;
from 18.75 gr to 24.95 gr of the particles of the at least one food grade sugar; and
from 0.025 gr wt. % to 2.5 gr of the at least one food grade fat substance.
[8] The composition according to embodiment [1] or [6], wherein said composition comprises up to 3.4 wt. %, preferably up to 0.44 wt. %, of the at least one food grade additive, and wherein said at least one food grade additive is selected from the group consisting of food grade preservatives, food grade flavoring agents and food grade coloring agents.
[9] The composition according to embodiment [1] or [6], wherein said composition comprises up to 3.4 wt. %, preferably up to 0.44 wt. %, of the at least one food grade additive, and wherein said at least one food grade additive is selected from the group consisting of food grade flavoring agents and food grade coloring agents.
[10] The composition according to embodiment [6], wherein said composition with respect to the total weight of the composition, consists of the following ingredients:
from 0.1 wt. % to 15 wt. % of the particles of cocoa;
from 74.9 wt. % to 99.8 wt. % of the particles of the at least one food grade sugar; and
from 0.1 wt. % to 10 wt. % of the at least one food grade fat substance.
[11] The composition according to embodiment [10], wherein with respect to the total weight of the composition and per 25 gr of the composition, said composition consist of:
from 0.025 gr to 3.75 gr of the particles of the cocoa;
from 18.75 gr to 24.95 gr of the particles of the at least one food grade sugar; and
from 0.025 gr wt. % to 2.5 gr of the at least one food grade fat substance.
[12] The composition according to any one of embodiments [1] and [6] to [11], wherein the particles of cocoa are selected from the group consisting of cocoa powders.
[13] The composition according to embodiment [12], wherein the particles of cocoa are selected form the group consisting of alkalinized unsweetened cocoa powders containing at least 97 wt. % cocoa.
[14] The composition according to any one of embodiments [1] and [6] to [11] wherein the particles of cocoa are particles of a dehydrated cocoa liquor.
[15] The composition according to any one of embodiments [1] to [14], wherein the particles of the at least one food grade sugar is a granulated sugar, a superfine sugar or a powdered sugar.
[16] The composition according to any one of embodiments [1] to [15], wherein the at least one food grade sugar is selected from the group consisting of caster sugar, cane sugar, beets sugar, brown sugar, xylitol, coconut sugar and date sugar.
[17] The composition according to any one of embodiments [1] to [15], wherein the at least one food grade sugar is honey or a derivative thereof, said honey or derivative thereof being in a dehydrated form.
[18] The composition according to any one of embodiments [1] to [15] wherein the at least one food grade sugar is churned honey in a dehydrated form, or honey sugar.
[19] The composition according to any one of embodiments [1] to [15], wherein the at least one food grade sugar is selected from the group consisting of maple syrup, in dehydrated form.
[20] The composition according to any one of embodiments [1] to [15], wherein the at least one food grade sugar is maple shoot in dehydrated form, or maple sugar.
[21] The composition according to any one of embodiments [1] to [20], wherein the at least one food grade fat substance is selected from the group consisting of milk butters, cocoa butters, derivatives of cocoa butters, coconut butters, derivatives of coconut butters, margarines, derivatives of margarines, palm oils, derivatives of palm oils, lard, derivatives of lard, and shea butters.
[22] The composition according to any one of embodiments [1] to [21], wherein the composition and/or ingredients making part of said composition, are substantially free of water. Preferably, said composition and/or ingredients making part of said composition are in a dehydrated form and substantially free of water.
[23] The composition according to any one of embodiments [1] to [21], wherein the composition and/or ingredients making part of said composition, are free of water. Preferably, said composition and/or ingredients making part of said composition are in a dehydrated form and free of water.
[24] The composition according to any one of embodiments [1] to [23], wherein the composition and/or ingredients making part of said composition, are substantially free of impurities.
[25] The composition according to any one of embodiments [1] to [23], wherein the composition and/or ingredients making part of said composition, are free of impurities.
[26] A method for preparing the composition defined in any one of embodiments [1] to [25], wherein the ingredients making part of said composition are mixed together to form a homogeneous composition.
[27] The method according to embodiment [26], wherein the ingredients making part of said composition, are mixed together at room temperature until obtaining a homogeneous composition.
[28] A method for manufacturing cotton candy, said method comprising the steps:
providing the composition defined in any one of embodiments [1] to [25] into a recipient provided with a top opening and co-axially driven in rotation around a substantially vertical axis;
heating the composition to melt the same into a liquid phase; and
collecting filaments of the composition escaping the recipient under the centrifugal force and forming solid filaments while cooling into the air.
[29] The method according to embodiment [28], wherein liquid phase is obtained at a temperature varying from 155° C. to 170° C.
[30] A cotton candy whenever obtained by the method defined in embodiment [28] or [29].
[31] A use of the composition defined in any one of embodiments [1] to [25], for the preparation of cotton candy.

Another embodiment of the invention relates to the composition defined hereinabove, wherein the at least one food grade sugar is substantially free of water, preferably free of water. More preferably, the at least one food grade sugar is in a dehydrated form and substantially free of water, and much more preferably in a dehydrated from and free of water.

Another embodiment of the invention relates to the composition defined hereinabove, wherein the at least one food grade sugar is substantially free of impurities, preferably free impurities. More preferably, the at least one food grade sugar is in a dehydrated form and substantially free of impurities, and much more preferably in a dehydrated form and free of impurities.

Another embodiment of the invention relates to the composition defined hereinabove, wherein the at least one food grade fat substance is substantially free of water, and preferably free of water. More preferably, the at least one food grade fat substance is in a dehydrated form and substantially free of water, and much more preferably in a dehydrated form and free of water.

Another embodiment of the invention relates to the composition defined hereinabove, wherein the at least one food grade fat substance is substantially free of impurities, and preferably free of impurities. More preferably, the at least one food grade fat substance is in a dehydrated form and substantially free of impurities, and much more preferably in a dehydrated form and free of impurities.

Another embodiment of the invention relates to the composition defined hereinabove, wherein the at least one food grade additive is substantially free of water, and preferably free of water. More particularly, the at least one additive is in a dehydrated form and substantially free of water, and much more preferably in a dehydrated form and free of water. Preferably, an example of said at least one food grade additive may be selected from the group consisting of dehydrated, dark chocolate natural flavor and dehydrated, milk chocolate natural flavor.

Another embodiment of the invention relates to the composition defined hereinabove, wherein the composition is substantially free of water, and preferably the composition is free of water. More particularly, the composition is in a dehydrated form and substantially free of water, and much more preferably in a dehydrated form and free of water.

Another embodiment of the invention relates to a method for preparing the composition defined hereinabove, wherein the above-mentioned ingredients making part of the composition are mixed together by any appropriated means, such as in a mixer, to form a homogeneous mixture. Preferably, the mixer is of any type commonly used in a kitchen (e.g. a spoon, a hand mixer or a stand mixer), or alternatively any type of mixers commonly used in a commercial or industrial kitchen. Preferably, the mixing of the ingredients is carried out at room temperature.

Another embodiment of the invention relates to the method defined hereinabove, wherein the mixing of the ingredients is carried out in any appropriate conditions allowing to avoid and/or to minimize an eventual uptake of water from the humidity of the surrounding atmosphere. Preferably, the mixing step may be carried out in a controlled environment, and more preferably the mixing may be carried out in a local or a capacity where the temperature and the relative humidity is controlled by any appropriate means to provide a dry environment at room temperature. Of course, this can be achieved by any appropriate means well known to persons skilled in the art, such as ventilation, dehumidifier, etc. Also, as an example, the mixing time may be as short as possible (i.e. just the time required to obtain a homogeneous composition). Also, alternatively, the resulting composition may be dried by any appropriate means well known in the art.

Another embodiment of the invention relates to a method for manufacturing cotton candy, said method comprising the steps:

providing the composition defined hereinabove into a recipient provided with a top opening and co-axially driven in rotation around a substantially vertical axis;
heating the composition to melt the same into a liquid phase; and
collecting filaments of the composition escaping the bowl under the centrifugal force and forming solid filaments while cooling into the air.

Another embodiment of the invention relates to the method defined hereinabove, wherein the liquid phase is obtained at a temperature varying from 155° C. to 170° C.

Another embodiment of the invention relates to a cotton candy whenever obtained by the method defined hereinabove.

Another embodiment of the invention relates to a use of the composition defined hereinabove, for the preparation of cotton candy.

### PREFERRED EMBODIMENTS OF THE INVENTION

The present invention will be better understood with reference to the following non-limiting examples illustrating some of the preferred embodiments of the invention.

### Example 1

Preparation of a composition useful for the preparation of cotton candy, said composition being prepared with particles of dehydrated cane sugar and particles of dehydrated, cocoa butter.

23.5 gr of the particles of the dehydrated cane sugar and 1.5 gr of the particles of the dehydrated, cocoa butter were placed in a bowl and hand-mixed with a spoon at room temperature, until obtaining 25 gr of a homogeneous mixture defining the composition. The cane sugar and the dehydrated, cocoa butter were substantially exempt from humidity, and the mixing was carried out in a controlled environment to prevent the ingredients and the resulting composition to uptake water from the atmospheric humidity. The controlled environment was a laboratory room comprising ventilation means to maintain the temperature around room temperature (20-25° C.), and have dried relative humidity (e.g. less than 30%). Then, the homogeneous composition was immediately put into a sealed container to prevent any uptake of water from the atmospheric humidity.

### Example 2

25 gr of the composition obtained in example 1 were placed in a preheated rotating recipient of an electric commercial cotton candy device known under the trade name VEVOR and provided with a stainless steel bowl and rotating recipient.

The heating gradient was first set to 100% until the composition was liquified and started to escape from the rotating recipient to form uniform filaments of the composition cooling within the stainless-steel bowl to form fluffy filaments of the composition (i.e. filaments of cotton candy). Once filaments of the composition escaped from the rotating recipient, the heating gradient was reduced to 90%. Said fluffy filaments were recovered from the bowl with a stick moved therein.

The cotton candy so obtained was then immediately place into a sealed container to prevent any uptake of water from the atmospheric humidity. This cotton candy surprisingly shows a silky and creamy texture, is tasty and delectable, and kept these properties for at least one month in a sealed container.

### Example 3

Preparation of a composition useful for the preparation of cotton candy, said composition being prepared from particles of dehydrated, maple sugar and particles of dehydrated, clarified butter.

25 gr of particles of dehydrated maple sugar and 0.5 gr of dehydrated clarified butter were placed in a bowl and hand-mixed with a spoon at room temperature, until obtaining 25.5 gr of a homogeneous composition. The particles of dehydrated, maple sugar and the particles of dehydrated, clarified butter were substantially exempt from humidity, and the mixing was carried out in a controlled environment to prevent the ingredients and the resulting composition to uptake water from the atmospheric humidity. The controlled environment was a laboratory room comprising ventilation means to maintain the temperature around room temperature (20-25° C.), and have dried relative humidity (e.g. less than 30%). Then, the homogeneous composition was immediately put into a sealed container to prevent any uptake of water from the atmospheric humidity.

### Example 4

25.5 gr of the composition obtained in example 3 were placed in a preheated rotating recipient of an electric commercial cotton candy device known under the trade name VEVOR and provided with a stainless steel bowl and rotating recipient.

The heating gradient was first set to 100% until the composition was liquified and started to escape from the rotating recipient to form uniform filaments of the composition cooling within the stainless-steel bowl to form fluffy filaments of the composition (i.e. filaments of cotton candy). Once filaments of the composition escaped from the rotating recipient, the heating gradient was reduced to 90%. Said fluffy filaments were recovered from the bowl with a stick moved therein.

The cotton candy so obtained was then immediately place into a sealed container to prevent any uptake of water from the atmospheric humidity. This cotton candy surprisingly shows a silky and creamy texture, is tasty and delectable, and kept these properties for at least one month in a sealed container.

### Example 5

Preparation of a composition useful for the preparation of cotton candy, said composition being prepared with particles of dehydrated, cocoa powder, particles of raw cane sugar and particles of dehydrated, powdered cocoa butter.

0.962 gr of particles of the particles of the dehydrated, cocoa powder; 24.038 gr of particles of raw cane sugar; and 0.5 gr of particles of dehydrated, powdered cocoa butter were placed in a bowl and hand-mixed with a spoon at room temperature, until obtaining 25.5 gr of a homogeneous composition. The particles of the dehydrated, cocoa powder, the particles of raw cane sugar and the particles of the dehydrated, powdered cocoa butter were substantially exempt from humidity, and the mixing was carried out in a controlled environment to prevent the ingredients and the resulting composition to uptake water from the atmospheric humidity. The controlled environment was a laboratory room comprising ventilation means to maintain the temperature around room temperature (20-25° C.), and have dried relative humidity (e.g. less than 30%). Then, the homogeneous composition was immediately put into a sealed container to prevent any uptake of water from the atmospheric humidity.

### Example 6

25.5 gr of the composition obtained in example 5 were placed in a preheated rotating recipient of an electric commercial cotton candy device known under the trade name VEVOR and provided with a stainless steel bowl and rotating recipient.

The heating gradient was first set to 100% until the composition was liquified and started to escape from the rotating recipient to form uniform filaments of the composition cooling within the stainless-steel bowl to form fluffy filaments of the composition (i.e. filaments of cotton candy). Once filaments of the composition escaped from the rotating recipient, the heating gradient was reduced to 90%. Said fluffy filaments were recovered from the bowl with a stick moved therein.

The cotton candy so obtained was then immediately place into a sealed container to prevent any uptake of water from the atmospheric humidity. This cotton candy surprisingly shows a silky and creamy texture, is tasty and delectable, and kept these properties for at least one month in a sealed container.

### Example 7

Preparation of a composition useful for the preparation of cotton candy, said composition being prepared with particles of dehydrated, cocoa powder; particles of a dehydrated, maple sugar; and particles of a dehydrated, powdered clarified butter.

0.962 gr of the particles of the dehydrated, cocoa powder; 24.038 gr of the particles of the dehydrated, maple sugar; and 0.5 gr of particles of the dehydrated, powdered clarified butter were placed in a bowl and hand-mixed with a spoon at room temperature, until obtaining 25.5 gr of a homogeneous composition. The particles of the dehydrated, cocoa powder, the particles of the dehydrated maple sugar and the particles of the dehydrated, clarified butter were substantially exempt from humidity, and the mixing was carried out in a controlled environment to prevent the ingredients and the resulting composition to uptake water from the atmospheric humidity. The controlled environment was a laboratory room comprising ventilation means to maintain the temperature around room temperature (20-25° C.), and have dried relative humidity (e.g. less than 30%). Then, the homogeneous composition was immediately put into a sealed container to prevent any uptake of water from the atmospheric humidity.

### Example 8

25.5 gr of the composition obtained in example 7 was placed in a preheated rotating recipient of an electric commercial cotton candy device known under the trade name VEVOR and provided with a stainless steel bowl and rotating recipient.

The heating gradient was first set to 100% until the composition was liquified and started to escape from the rotating recipient to form uniform filaments of the composition cooling within the stainless-steel bowl to form fluffy filaments of the composition (i.e. filaments of cotton candy). Once filaments of the composition escaped from the rotating recipient, the heating gradient was reduced to 90%. Said fluffy filaments were recovered from the bowl with a stick moved therein.

The cotton candy so obtained was then immediately place into a sealed container to prevent any uptake of water from the atmospheric humidity. This cotton candy surprisingly shows a silky and creamy texture, is tasty and delectable, and kept these properties for at least one month in a sealed container.

### Example 9

Preparation of a composition useful for the preparation of cotton candy, said composition being prepared with particles of dehydrated, cocoa powder, particles of dehydrated, raw cane sugar, and particles of dehydrated, powdered cocoa butter.

3.5 gr of the particles of the dehydrated cocoa powder; 21.6 gr of the particles of the dehydrated, raw cane sugar; and 0.4 gr of particles of the dehydrated, powdered cocoa butter were placed in a bowl and hand-mixed with a spoon at room temperature, until obtaining 25.5 gr of a homogeneous composition. The particles of the dehydrated, cocoa powder, the particles of the raw cane sugar and the particles of the dehydrated, powdered cocoa butter were substantially exempt from humidity, and the mixing was carried out in a controlled environment to prevent the ingredients and the resulting composition to uptake water from the atmospheric humidity. The controlled environment was a laboratory room comprising ventilation means to maintain the temperature around room temperature (20-25° C.), and have dried relative humidity (e.g. less than 30%). Then, the homogeneous composition was immediately put into a sealed container to prevent any uptake of water from the atmospheric humidity.

### Example 10

25.5 gr of the composition obtained in example 9 was placed in a preheated rotating recipient of an electric commercial cotton candy device known under the trade name VEVOR and provided with a stainless steel bowl and rotating recipient.

The heating gradient was first set to 100% until the composition was liquified and started to escape from the rotating recipient to form uniform filaments of the composition cooling within the stainless-steel bowl to form fluffy filaments of the composition (i.e. filaments of cotton candy). Once filaments of the mixture escaped from the rotating recipient, the heating gradient was reduced to 90%. Said fluffy filaments were recovered from the bowl with a stick moved therein.

The cotton candy so obtained was then immediately place into a sealed container to prevent any uptake of water from the atmospheric humidity. This cotton candy surprisingly shows a silky and creamy texture, is tasty and delectable, and kept these properties for at least one month in a sealed container.

### Example 11

Preparation of a composition useful for the preparation of cotton candy, said composition being prepared with particles of a dehydrated, cocoa powder, particles of dehydrated, raw cane sugar, and particles of a dehydrated, powdered cocoa butter.

1.3 gr of particles of the dehydrated, cocoa powder; 21.6 gr of the dehydrated, raw cane sugar; and 0.5 gr of the dehydrated, powdered cocoa butter were placed in a bowl and hand-mixed with a spoon at room temperature, until obtaining 25.5 gr of a homogeneous composition. The particles of the dehydrated, cocoa powder, the particles of the raw cane sugar and the particles of the dehydrated, powdered cocoa butter were substantially exempt from humidity, and the mixing was carried out in a controlled environment to prevent the ingredients and the resulting composition to uptake water from the atmospheric humidity. The controlled environment was a laboratory room comprising ventilation means to maintain the temperature around room temperature (20-25° C.), and have dried relative humidity (e.g. less than 30%). Then, the homogeneous composition was immediately put into a sealed container to prevent any uptake of water from the atmospheric humidity.

### Example 12

25.5 gr of the composition obtained in example 11 were placed in a preheated rotating recipient of an electric commercial cotton candy device known under the trade name VEVOR and provided with a stainless steel bowl and rotating recipient.

The heating gradient was first set to 100% until the composition was liquified and started to escape from the rotating recipient to form uniform filaments of the composition cooling within the stainless-steel bowl to form fluffy filaments of the composition (i.e. filaments of cotton candy). Once filaments of the mixture escaped from the rotating recipient, the heating gradient was reduced to 90%. Said fluffy filaments were recovered from the bowl with a stick moved therein.

The cotton candy so obtained was then immediately place into a sealed container to prevent any uptake of water from the atmospheric humidity. This cotton candy surprisingly shows a silky and creamy texture, is tasty and delectable, and kept these properties for at least one month in a sealed container.

### Example 13

Preparation of a composition useful for the preparation of cotton candy, said composition being prepared with particles of dehydrated cocoa powder, particles of dehydrated, raw cane sugar, particles of a dehydrated, powdered cocoa butter and particles of a dehydrated, dark chocolate natural flavour.

0.962 gr of the particles of the dehydrated, cocoa powder; 24.038 gr of the particles of the dehydrated, raw cane sugar; 0.5 gr of the particles of the dehydrated, powdered cocoa butter and 0.8 gr of particles of the dehydrated, dark chocolate natural flavour were placed in a bowl and hand-mixed with a spoon at room temperature, until obtaining 26.3 gr of a homogeneous composition. The particles of the dehydrated, cocoa powder, the particles of the raw cane sugar, the particles of the dehydrated, powdered cocoa butter, and the particles of dehydrated, dark chocolate natural flavour were substantially exempt from humidity, and the mixing was carried out in a controlled environment to prevent the ingredients and the resulting composition to uptake water from the atmospheric humidity. The controlled environment was a laboratory room comprising ventilation means to maintain the temperature around room temperature (20-25° C.), and have dried relative humidity (e.g. less than 30%). Then, the homogeneous composition was immediately put into a sealed container to prevent any uptake of the atmospheric humidity.

### Example 14

26.3 gr of the composition obtained in example 13 were placed in a preheated rotating recipient of an electric commercial cotton candy device known under the trade name VEVOR and provided with a stainless steel bowl and rotating recipient.

The heating gradient was first set to 100% until the composition was liquified and started to escape from the rotating recipient to form uniform filaments of the composition cooling within the stainless-steel bowl to form fluffy filaments of the composition (i.e. filaments of cotton candy). Once filaments of the compositions escaped from the rotating recipient, the heating gradient was reduced to 90%. Said fluffy filaments were recovered from the bowl with a stick moved therein.

The cotton candy so obtained was then immediately place into a sealed container to prevent any uptake of water from the atmospheric humidity. This cotton candy surprisingly shows a silky and creamy texture, is tasty and delectable, and kept these properties for at least one month in a sealed container.

### Example 15

Preparation of a composition useful for the preparation of cotton candy, said composition being prepared with particles of a dehydrated, cocoa powder, particles of dehydrated, raw cane sugar, particles of a dehydrated, clarified butter, and particles of a dehydrated milk chocolate natural flavour.

2.43 gr of the particles of the dehydrated, cocoa powder; 21.57 gr of the particles of the dehydrated, raw cane sugar, 1 gr of the particles of the dehydrated, clarified butter, and 0.8 gr of the particles of the dehydrated, milk chocolate natural flavour were placed in a bowl and hand-mixed with a spoon at room temperature, until obtaining 26.5 gr of a homogeneous composition. The particles of the dehydrated, cocoa powder, the particles of the raw cane sugar, the particles of the dehydrated, clarified butter, and the particles of dehydrated, milk chocolate natural flavour were substantially exempt from humidity, and the mixing was carried out in a controlled environment to prevent the ingredients and the resulting composition to uptake water from the atmospheric humidity. The controlled environment was a laboratory room comprising ventilation means to maintain the temperature around room temperature (20-25° C.), and have dried relative humidity (e.g. less than 30%). Then, the homogeneous mixture was immediately put into a sealed container to prevent any uptake of water from the atmospheric humidity.

### Example 16

26.5 gr of the composition obtained in example 15 were placed in a preheated rotating recipient of an electric commercial cotton candy device known under the trade name VEVOR and provided with a stainless steel bowl and rotating recipient.

The heating gradient was first set to 100% until the composition was liquified and started to escape from the rotating recipient to form uniform filaments of the composition cooling within the stainless-steel bowl to form fluffy filaments of the composition (i.e. filaments of cotton candy). Once filaments of the composition escaped from the rotating recipient, the heating gradient was reduced to 90%. Said fluffy filaments were recovered from the bowl with a stick moved therein.

The cotton candy so obtained was then immediately place into a sealed container to prevent any uptake of water from the atmospheric humidity. This cotton candy surprisingly shows a silky and creamy texture, is tasty and delectable, and kept these properties for at least one month in a sealed container.

The present invention has been described with respect to its preferred embodiments. The description and examples are only intended to aid to the understanding of the invention and are not intended to limit its scope. It will be clear to those skilled in the art that numerous variations and modifications can be made to the implementation of the invention without being outside the scope of the invention. Such variations and modifications are covered by the present invention. The invention will be now described in the following claims:

1. A composition for the preparation of cotton candy, said composition being a homogeneous mixture comprising with respect to the total weight of the composition, the following ingredients:
from 71.6 wt. % to 99.9 wt. % of particles of at least one food grade sugar;
from 0.1 wt. % to 10 wt. % of at least one food grade fat substance;
from 0 to 15 wt % of particles of cocoa; and
from 0 to 3.4 wt % of at least one food grade additive.

2. The composition according to claim 1, wherein said composition comprises with respect to the total weight of the composition, the following ingredients:
from 90 wt % to 99.9 wt. % of the particles of the at least one food grade sugar; and
from 0.1 wt. % to 10 wt. % of the at least one food grade fat substance.

3. The composition according to claim 1, wherein said composition comprises up to 3.4 wt. % of the at least one food grade additive, and wherein said at least one food grade additive is selected from the group consisting of food grade preservatives, food grade flavoring agents and food grade coloring agents.

4. A composition according to claim 1, wherein said composition comprises with respect to the total weight of the composition, the following ingredients:
from 0.1 wt. % to 15 wt. % of the particles of cocoa;
from 74.9 wt. % to 99.8 wt. % of the particles of the at least one food grade sugar; and
from 0.1 wt. % to 10 wt. % of the at least one food grade fat substance.

5. The composition according to claim 4, wherein said composition comprises up to 3.4 wt. % of the at least one food grade additive, and wherein said at least one food grade additive is selected from the group consisting of food grade preservatives, food grade flavoring agents and food grade coloring agents.

6. The composition according to claim 4, wherein the particles of cocoa are selected from the group consisting of cocoa powders.

7. The composition according to claim 4, wherein the particles of cocoa are selected form the group consisting of alkalinized unsweetened cocoa powders containing at least 97 wt. % cocoa.

8. The composition according to claim 6, wherein the particles of cocoa powders are particles of a dehydrated cocoa liquor.

9. The composition according to claim 1, wherein the particles of the at least one food grade sugar is a granulated sugar, a superfine sugar or a powdered sugar.

10. The composition according to claim 1, wherein the at least one food grade sugar is selected from the group consisting of caster sugar, cane sugar, beets sugar, brown sugar, xylitol, coconut sugar and date sugar.

11. The composition according to claim 1, wherein the at least one food grade sugar is honey or a derivative thereof, said honey or derivative thereof being in a dehydrated form.

12. The composition according to claim 1, wherein the at least one food grade sugar is churned honey in a dehydrated form, or honey sugar.

13. The composition according to claim 1, wherein the at least one food grade sugar is selected from the group consisting of maple syrup, in dehydrated form.

14. The composition according to claim 1, wherein the at least one food grade sugar is maple shoot in dehydrated form, or maple sugar.

15. The composition according to claim 1, wherein the at least one fat substance is selected from the group consisting of milk butters, cocoa butters, derivatives of cocoa butters, coconut butters, derivatives of coconut butters, margarines, derivatives of margarines, palm oils, derivatives of palm oils, lard, derivatives of lard, and shea butters.

16. The composition according to claim 1, wherein the composition and/or ingredients making part of the composition, are substantially free of water.

17. The composition according to claim 1, wherein the composition and/or ingredients making part of the composition, are substantially free of impurities.

18. A method for preparing the composition defined in claim 1, wherein the ingredients making part of the composition, are mixed together to form a homogeneous mixture.

19. The method according to claim 18, wherein the ingredients are mixed at room temperature until obtaining a homogeneous mixture.

20. A method for manufacturing cotton candy, said method comprising the steps:
providing the composition defined in claim 1 into a recipient provided with a top opening and co-axially driven in rotation around a substantially vertical axis;
heating the composition to melt the same into a liquid phase; and
collecting filaments of the composition escaping the recipient under the centrifugal force and forming solid filaments while cooling into the air.

21. The method according to claim 20, wherein liquid phase is obtained at a temperature varying from 155° C. to 170° C.

22. A cotton candy whenever obtained by the method defined in claim 20.
